(19) United States
(12) Patent Application Publication
(10) Pub. No.: US 2009/0199077 A1
(43) Pub. Date: Aug. 6, 2009

(54) Creating first class objects from web resources

(76) Inventors: Can Sar, Stanford, CA (US); Jesse Young, Belmont, CA (US); Tristan Harris, San Francisco, CA (US)

Correspondence Address: PILLSBURY WINTHROP SHAW PITTMAN LLP, P.O. BOX 10500, MCLEAN, VA, 22102, US

(21) Appl. No.: 12/321,596

(22) Filed: Jan. 21, 2009

Related U.S. Application Data
(60) Provisional application No. 61/021,892, filed on Jan. 17, 2008.

(51) Int. Cl. G06F 17/00; G06F 17/21

(52) U.S. Cl. 715/201

(57) ABSTRACT

The present inventions are directed to apparatus and method for creating first class object representations from web pages that are not normally considered first class objects.

The present application relates to and claims priority from U.S. Provisional Appln No. 61/021,892 filed Jan. 17, 2008, and entitled “Creating First Class Objects From Web Resources”, the contents of which are expressly incorporated by reference herein.

### BACKGROUND OF THE INVENTION

Since our example implementation describes the use of a system in a web browser we want to distinguish it from an existing concept that might sound superficially similar. Certain websites already allow the user to enter particular URLs (e.g. the url of a YouTube Video) and will display their content in some way as part of another webpage, e.g. embedding the YouTube video in a webpage. To these systems, however, the video is just an embed code with a URL that points to YouTube while in our system it is a first class object with class specific properties and methods—a YouTube video in our system, as described hereinafter, supports very different methods from a Stock Chart. This allows us to attach a wide array of functionality to the objects that might not have been originally supported by the source that we were loading them from (such as the ability to add layover graphics or labels to images). It also allows them to behave differently depending on the class of object at hand, and to share functionality between different classes of the same category (e.g. both YouTube Video and Veoh Video classes derive from the Video class which implements the ‘getVideoLength’ function which is inherited by both child classes). Finally, it means that the different objects can communicate via a rich and well-specified API. This makes mashups between data and objects from different sources much simpler than it currently is. Instead of having to write custom wrappers, filters, and extensions using JavaScript code to make different widgets, APIs and applications talk to each other through standard interfaces between all of them.

### SUMMARY

The present inventions are directed to apparatus and method for creating first class object representations from web pages that are not normally considered first class objects. In one aspect, there is provided a method of representing each of a plurality of web objects that are within a plurality of predetermined classes of web objects as a first class object representation comprising the steps of: inputting each of the plurality of web objects that are within a plurality of predetermined classes of web objects into a computer system; reviewing each of the plurality of web objects using a software program executed by the computer system, the reviewing including: for each web object that is one of a plurality of previously instantiated objects having the first class representation, using the software program executed by the computer system to associate any additional and known data fields that exist that can be used when further processing of each web object occurs; for each web object that is not one of the plurality of previously instantiated objects, ensuring that each web object has a minimum predetermined set of data fields so that each web object can become one of the plurality of previously instantiated objects having the first class representation using the software program executed by the computer system, the step of ensuring including: for some web objects, determining that the web object as input into the computer system has the minimum predetermined set of data fields and identifying each of those some objects as having the first class representation; and for each of other web objects, determining that the other web object as input into the computer system does not have the minimum predetermined set of data fields, associating any additional and known to the computer data fields corresponding to the other web object, transmitting a request to an external source for further data fields sufficient for the other web object to obtain the first class representation, receiving the response to the transmitted request at the computer system, wherein the response received includes received data fields; and associating the received data fields with the other web object to obtain the minimum predetermined set of data fields and thereby identify the other web object as having the first class representation.

### BRIEF DESCRIPTION OF THE DRAWINGS

These and other aspects and features of the present invention will become apparent to those of ordinary skill in the art upon review of the following description of specific embodiments of the invention in conjunction with the accompanying figures, wherein:

FIG. 1 illustrates an overview of resources to that can be used to obtain field information for first class object representations according to an embodiment of the invention.

### DETAILED DESCRIPTION OF THE PREFERRED EMBODIMENTS

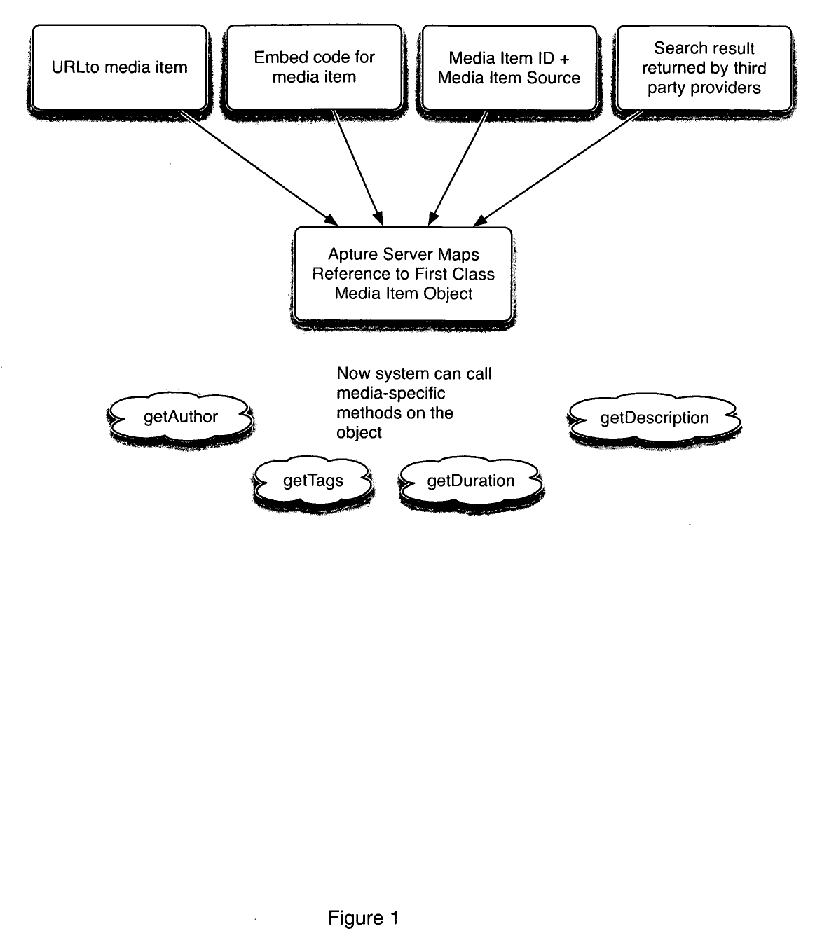

The present invention includes a list of first class types that it supports such as a YouTube Video, a Wikipedia Article, an Amazon Stock Chart, etc. These objects can be created in a variety of ways: manually created by a program by setting all of the member variables of a new object, from the information returned by search providers in our system (Yahoo Image Search, YouTube Video Search), by the user specifying a URL that points to a web resource that includes information about the object or the object itself, from an HTML Embed Code, or by any other description that contains enough information to create the necessary object as shown in FIG. 1. Once the object has been created (e.g. from a search result) it is indistinguishable from an object with the same information that was created in a different manner (e.g. from a URL). Furthermore, these objects now behave like any other first class object and can inherit from other objects and have custom methods defined on them. Finally, these objects can also recognize the fact that they are identical so that both instantiations of the same object will share the same data and their use can be tracked as if they were the same object. Thus, further described herein is a method of creating first class objects that know how to flexibly create themselves given a number of different data sources.

Let us describe a possible implementation of such an Object creation system, also referred to as an Apture creation system that has Apture logic classes. Our implementation will consist of a web server that will store all the necessary data and be able to connect to other networked computers and a website which the user will interact with which will be sending commands to the web server and receiving data from it. Alternatively the same technology could be implemented as one single program with a GUI instead of an attached website. Apture object classes are currently implemented using object orientation in the JavaScript and Python programming languages and are fundamentally regular objects with several special fields and many special instantiation methods that are described below. These functions know how to create the objects given a wide range of parameters and will do different things depending on the class of the object and the amount of data passed to the instantiation method. They would work analogously in any other object oriented programming language and could be used in non object oriented languages in the same way that other object oriented constructs are translated (e.g. structures and functions in the C programming language).

Each Apture Object class has to specify a list of unique lookup keys (every object must have at least one key), for a Flickr Photo one such key would be its flickrId. It also has to specify a list of fields which need to be filled in to make this item ‘canonical’ (explained below), for the Flickr Photo these are its flickrId, url, height, width, description, and author id. In addition, each Object class has a list of functions with which it can be instantiated, e.g. Flickr Photo can be instantiated from their flickrId or their URL. Almost all objects can be instantiated from their unique id, most of them from a URL that points to information about the item (e.g. the URL of a flickr Photo, or the webpage of a YouTube Video), and many of them from an HTML Embed code for that object (e.g. a YouTube or Veoh Embed code). Classes that can be instantiated from URLs or Embed codes need to specify a list of regular expressions of both URLs and Embed codes that its instantiation methods can understand as described below. Finally, each class can have any number of other custom functions and fields that define class specific functionality.

Classes can also define arbitrarily many other instantiation methods, e.g. one could potentially create a YouTube Video instantiation method called newFromVoice where a user could simply say the YouTube Id of a video (e.g. bCftkirSpHE) into a voice recognition system which would convert said letters into a string of characters which would then be passed to the YouTube Video newFromId constructor which knows how to create a new object from the id. In computing, a first-class object (also value, entity, and citizen), in the context of a particular programming language, is an entity which can be used in programs without restriction (when compared to other kinds of objects in the same language).

First-class objects are said to belong to a first-class data type. Described herein is a method of taking web “objects” (resources, things, etc.) and from them create actual programming language objects (e.g. Python and JavaScript classes) that represent these objects as a first class object representation. E.g. the FlickrPhoto class would describe Flickr photos and an instance of the FlickrPhoto class would represent a particular Flickr photo. A class would specify a series of fields that each instance of this class must have (e.g. and ID, an author, a source url, a height, a width, and date where it was taken for FlickrPhoto) as well as functions that manipulate it, as described hereinafter. The exact functions that each class defines depend on the particular source web object—for instance all classes that represent images (e.g JPG, or GIFs) can be resized because the underlying object can be resized (with an image manipulation program) and all instances of the YouTubeVideo class can be resized because YouTube videos can be resized while the ComedyCentralVideo class is not resizable (and sets the Resizable=False property to indicate this) because Comedy Central videos do not define a resize method.

By obtaining a first class object representation, this allows one to provide a way in which one can represent any web object in a programming language so that it can be manipulated by code in that programming language. Each new type of object may require some custom code to be written for it, as described herein.

As an overview, as described hereinafter, when the system, which is software program being executed by a processor or processors that are on a server, computer, or group of computers or servers, is presented with an ID (specified in the class specification) the system will then see if it has already canonicalized the object (as described in the provisional) and if not fetch it (using the function specified in the class specification). This fetching function will then populate the fields of the object which use a special description system that makes it easy and fast to describe the object (as seen in the example below) and then create a new class and link this class into the class hierarchy. After this any of the user specified methods or those methods of parent functions can be called, For each new type of object (such as Type: YouTube video, Reuters Photo) there is a small amount of code has to be written in order to add a new class of web resource to the system, the following list specifies the things that a programmer has to define to describe a new class:

List of keys: Each class of object must define a list of unique keys—a new object can be initialized given a value for any of the keys—the system first checks if a canonicalized object already exists for this key (as explained in the provisional) and otherwise calls the fetching code described in the next bullet.

A way to retrieve the actual object: Given an ID we then need a way to retrieve the actual data about this object. Each new class needs some code in order to load this additional information—in practice, however, most classes can inherit this code from other classes that load information in the same way. Many services provide HTTP APIs to return information about a particular item given its ID and we have libraries that read data from APIs with many different data formats (e.g. XML, JSON, . . . ) so the implementer must simply specify which API fields correspond to which Class fields (example in the code below). In general, however, implementers can write arbitrarily complex fetchCanonicalItem functions—as long as it is possible to write a function to retrieve this information (and the web resource has a unique key that identifies it) the web resource can be integrated into our system.

Object Fields: A list of properties for this object. Fields may be constant (the same for all instances), stored (stored in the database), or Automatic (generated from other fields that are stored).

Position in the class Hierarchy: Does this class fall into an existing branch of the class hierarchy of already defined classes (e.g. if we have already defined an Image class with a set of common fields and functions that would be used by other images, the FlickrImage class would inherit from it) or is it entirely new (in which case its parent is the special class is ‘Item’), and example of such a new class would be the Image class.

Optional set of functions to manipulate the object:

As explained above, many classes define functions that can operate on their data. The amount of functions defined depends on the complexity of the class—most classes that inherit from the Video class only define their own start and stop function while the GoogleMap class defines many functions to among other things, set the Zoom Level, se the Initial Position, change the Map Mode (e.g. show Street Names, Satellite Image, . . . ) and many others.

EXAMPLE, FlickrImage (Python):

class FlickrImage(Image):

flickrId = StoredField(key=True)
prettySource = ConstField(‘Flickr’)
faviconUrl = AutoField(lambda self: “favicons/flickr.gif?2”)
class Meta(object):

allowAutoLink = True
urlRegexes = (r‘http://www\.flickr\.com/photos/(?P<userId>[\w\@0-9\-

_]+)/(?P<flickrId>[0-9\-_]+)’,

r‘http://farm[0-9]*.static.flickr.com/([0-9]+)/(?P<flickrId>[0-9]+)_.*’)

def fetchCanonicalItem(self):

from news.newslink.apis import FlickrProvider
res = FlickrProvider( ).getItemById(self.flickrId)
if self.url and res.url != self.url:

res.url = self.url

return res

......
class FlickrProvider(APIProvider):
.....
def getItemById(self, flickrId):

xmlResult = self.loadXML(self.doHTTPRequest(method=‘flickr.photos.getInfo’,

photo_id=flickrId))

res = self.extractItemFromInfoRow(xmlResult[0])
xmlSizeResult = self.loadXML(self.doHTTPRequest(method=‘flickr.photos.getSizes’,

photo_id=flickrId))

size = self.findFirstSize(SIZE_LIST, xmlSizeResult[0])
if size is not None:

res.width = int(str(size(‘width’)))
res.height = int(str(size(‘height’)))

res.url = str(size(‘source’))

else:

raise AptureInvalidItemException(“Flickr URL not found”)

thumbSize = self.findFirstSize(THUMB_SIZE_LIST, xmlSizeResult[0])
if thumbSize is not None:

res.previewUrl = str(thumbSize(‘source’))

return res

We will now describe several different ways of creating a ‘canonical’ object, also referred to as a first class object representation, using the Flickr Photo class as our example. An Apture object is termed ‘canonical’ when all of its required fields are filled in and when it has a globally unique Apture id. We will start with creating a Photo object from its Flickr Id which is most simple to explain. The programmer would call the newFromId instantiation method of the Flickr Photo Object and pass it a flickrId (e.g. ‘422143609’). Like all instantiation methods this will first try to canonicalize the object from the database to make sure that if an object with the same information already exists they will both have the same globally unique id. Since the object already has a flickrId it can look up this flickrId in the Apture data store (described below). If an Apture object for this Flickr Photo has been seen before there will be a record in the data store containing all the necessary fields. The instantiation method then simply sets its all the fields of the object to the fields read from the datastore, including its Apture Id. The object can then be referred to using this unique Apture Id and all instantiations of the Flickr Photo with flickrId ‘422143609’ will point to the same record in the data store.

If there was no record in the data store the instantiation method will then see which of the fields still remain to be filled in and which already exist by iterating through the list of required fields. Since there are still missing fields but the flickrId of the object is known it can simply use Flickr's public API and make a web service request to retrieve information about the photo with that flickrId. Flickr supports a variety of formats for its queries and results and we use the default XML format. The important thing to note is that like the Flickr Photo class each Apture object class has code to look up the information that still needs to be filled in, some use public web service APIs (Flickr, YouTube), others make calls to our own custom servers (the Wikipedia Image class queries our own local copy of Wikipedia about the license associated with a particular Wikipedia Image), and others fetch a piece of content from the internet and then analyze its content (regular Web Images are fetched from the internet and opened to determine their height and width). Once the necessary data has been loaded from the web the instantiation functions fills in the remaining fields with it. At this point the object is complete and any of its functions can be called. Importantly, at this point we can no longer tell how the object was created, creating it from a URL would give us the same exact object. It is, however, not yet canonical since it does not have an Apture Id yet, this will require saving it to the Apture Datastore at which point an id is assigned (describe below).

This example showed that we can create a new instance of a particular class given a unique identifier for that class. Creating an object of a known class (e.g. Flickr) from a URL for that class (e.g. ‘http://www.flickr.com/photos/_aliraza_{—}/422143609/’) is now simple, the above URL contains the flickrId so we can simply extract it and then pass it as an argument to newFromId.

However, we often want to create an object from a given URL without knowing what object the URL corresponds to. For this we use the URL regular expressions defined in many Apture class definitions. For a given URL the initialization function tries to find a matching object class by applying the regular expressions for each class to the specified URL. If one of the classes has a matching expression it will also extract a list of parameters specified in the regular expression that are needed to uniquely identify that object in that class (e.g. the Flickr Id for Flickr). In the case of the Flickr photo this is enough information to create the photo using newFromId. Embed code matching works analogously.

Many Apture classes can also be directly instantiated from a file and can specify a list of content types that they support. As an example the generic Apture Image class can be instantiated from the GIF, JPEG, or PNG content type and will open the image file to determine attributes like width and height. URLs that do not correspond to a regular expression in any of the Apture classes will instead be loaded from the web server after which the system will determine the content type of the document. The document is then passed to the constructor of a class that knows what do to with this content type. Another example is the Generic Web Page class (which accepts HTML types) which tries to extract information about what kind of Apture class might be represented by a document by applying regular expressions and custom parsers to it. A webpage which simply includes a YouTube Video or Flickr Photo will match the Embed expression and be turned into the corresponding type.

Having described many different ways of instantiating an object we will now return to talking about how these objects are stored. Our specific implementation uses a table in a Relational Database (e.g. MySQL) but any system that can store and query information quickly will work. We have two main requirements: since we have a large set of object classes we don't want to have to create a separate database table for each class but also want to be able to look up elements quickly given one of a potentially large set of unique keys. Since we are using a Relational Database all entries in each table must have the same table scheme so we decided to store objects inside a MySQL TextField in serialized form. When choosing how to serialize our objects we decide to store them as JSON text because they can then be directly passed to a web browser that will be able to convert them to JavaScript objects with little overhead. However, any other serialization format that is capable of storing objects will work as well (e.g. Python's standard serialization format). The id of the database record for an object is used as the globally unique Apture Id and is assigned by the database when an object is saved the first time and every future time it is loaded from the database.

We also have a separate lookup table that stores pair of key names, key values, and Apure Ids (e.g. “FlickrId” as the keyname and “422143609” as the key value) and has an index on the first two to allow for quick lookup. As described above each Apture Object class can specify a list of fields that can be used as lookup keys and at least one of these must be passed when instantiating a new object to make sure that identical objects can be retrieved so that the object can be canonicalzed. We use that key to look up an item in the database, retrieve it's field values and then simply pass them to one of the initialization functions which takes the individual field values and creates an object from them by looping through all the fields from the database and copying them to its own fields. Saving an object to the database works analogously—the saving code goes through all the fields in the object and converts them to the proper format and then simply saves that textual representation.

Although the present invention has been particularly described with reference to embodiments thereof, it should be readily apparent to those of ordinary skill in the art that various changes, modifications and substitutes are intended within the form and details thereof, without departing from the spirit and scope of the invention. Accordingly, it will be appreciated that in numerous instances some features of the invention will be employed without a corresponding use of other features. Further, those skilled in the art will understand that variations can be made in the number and arrangement of components illustrated in the above figures. It is intended that the scope of the appended claims include such changes and modifications.

What is claimed is:

1. A method of representing each of a plurality of web objects that are within a plurality of predetermined classes of web objects as a first class object representation comprising the steps of:
inputting each of the plurality of web objects that are within a plurality of predetermined classes of web objects into a computer system;
reviewing each of the plurality of web objects using a software program executed by the computer system, the reviewing including:
for each web object that is one of a plurality of previously instantiated objects having the first class representation, using the software program executed by the computer system to associate any additional and known data fields that exist that can be used when further processing of each web object occurs;
for each web object that is not one of the plurality of previously instantiated objects, ensuring that each web object has a minimum predetermined set of data fields so that each web object can become one of the plurality of previously instantiated objects having the first class representation using the software program executed by the computer system, the step of ensuring including:
for some web objects, determining that the web object as input into the computer system has the minimum predetermined set of data fields and identifying each of those some objects as having the first class representation; and
for each of other web objects,
determining that the other web object as input into the computer system does not have the minimum predetermined set of data fields,
associating any additional and known to the computer data fields corresponding to the other web object,
transmitting a request to an external source for further data fields sufficient for the other web object to obtain the first class representation,
receiving the response to the transmitted request at the computer system,
wherein the response received includes received data fields; and
associating the received data fields with the other web object to obtain the minimum predetermined set of data fields and thereby identify the other web object as having the first class representation.

2. The method according to claim 1 wherein the step of transmitting makes a request to an external source associated with the web object.

3. The method according to claim 1 wherein at least one of the objects is an image object and image content, a width and height are required in order to obtain the first class representation.

4. The method according to claim 1 wherein the at least one object is a text object, and a text field is required in order to obtain the first class representation.

5. The method according to claim 1 wherein at least one of the objects is a video object and video content, a width and height are required in order to obtain the first class representation.

6. The method according to claim 5 wherein a further obtained data field is video length.

7. The method according to claim 1 wherein the at least one object, after being designated as the first class object representation, has the capability to be manipulated using all functions of a member class associated with the at least one object.

8. A computer-readable medium for representing each of a plurality of web objects that are within a plurality of predetermined classes of web objects as a first class object representation, said program causing a computer to perform:
inputting each of the plurality of web objects that are within a plurality of predetermined classes of web objects into a computer system;
reviewing of each of the plurality of web objects, the reviewing including:
for each web object that is one of a plurality of previously instantiated objects having the first class representation, associating any additional and known to the computer data fields that can be used when further processing of each web object occurs;
for each web object that is not one of the plurality of previously instantiated objects, ensuring that each web object has a minimum predetermined set of data fields so that each web object can become one of the plurality of previously instantiated objects having the first class representation, the step of ensuring including:
for some web objects, determining that the web object as input has the minimum predetermined set of data fields and identifying each of those some objects as having the first class representation; and
for other web objects,
determining that the other web object as input does not have the minimum predetermined set of data fields,
associating any additional and known to the computer data fields corresponding to the other web object,
transmitting of a request to an external source for further data fields sufficient for the other web object to obtain the first class representation,
receiving a response to the transmitted request, wherein with the response received is included received data fields; and
associating the received data fields from each response with the other web object in order to obtain the minimum predetermined set of data fields and thereby identify the other web object as having the first class representation.
